(19) United States
(12) Patent Application Publication
(10) Pub. No.: US 2006/0248970 A1
(43) Pub. Date: Nov. 9, 2006

(54) Machine and method for converting a linear input to a rotational output

(76) Inventor: Richard Kunnas, Mansfield, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/123,368

(22) Filed: May 6, 2005

(51) Int. Cl. F16H 27/04

(52) U.S. Cl. 74/84 S

(57) ABSTRACT

The invention is a device that converts a linear input to a rotational output. The invention includes a system of one or more extendable and retractable members that actively change the radius of rotation of weights on the members. The members are connected to a rotatable member for rotation about a non-vertical axis. By actively changing the radius of rotation of a weight, a non-circular path is established for each weight to follow. This path is biased so that, while the weight has the greatest radius of rotation, it also is undergoing a downward stroke. While the weight is undergoing an upward stroke, the radius of rotation is at its minimum. The system thereby utilizes the force of gravity during transitions between maximum and minimum radii to produce a rotational output.

### FIELD OF THE INVENTION

The present invention relates generally to rotational machines and devices and more particularly to a gravity operated or assisted machine for supplying, conserving, and/or recovering energy, for example for the purpose of rotating a shaft.

### BACKGROUND

A variety of different devices utilizing gravity to produce a rotary output have been invented. Typically, such devices include one or more weights arranged on movable members and coupled for rotation with a rotating shaft. For example, in U.S. Pat. No. 6,694,844 to Love (“Love”) an apparatus to recover energy through gravitational force is disclosed having a wheel-like, connected, encircling surface, including an axially horizontal track which has an interior surface which weighted objects contact and are carried around the interior surface. The interior surface is a connected, encircling, wheel-like surface, is not a round circle or a cylinder, but has an offset center of rotation closest to a side which approaches perpendicular, the weighted objects are carried by spokes attached to a support hub through the offset center of rotation. A plurality of spokes extend diametrally of the track in axially and circumferentially spaced array. Weighted objects are mounted on opposite ends of each spoke. The offset center causes the spokes to move axially diametrally of the track and extend the weights to rise and lower as the weights traverse the path of the interior surface.

Similarly, U.S. Pat. No. 6,237,342 to Hurford (“Hurford”) discloses a gravity motor formed of at least one motor unit which has at least one motor member fixed to an output shaft. The output shaft is rotationally mounted on a housing. The housing includes a guide surface. The motor member is low frictionally longitudinally movable relative to an output shaft. Each end of the motor member includes a weighted follower which is low frictionally movable relative to a guide surface. The rotation of the motor unit will cause one weighted follower to be moved toward the output shaft by the guide surface with the opposite weighted follower of the motor member being moved away from the output shaft.

Existing devices, such as those described above, generally tend to require a significant amount of energy to operate due to the substantial frictional resistance inherent in such designs. Further, such devices do not operate in a manner that results in efficient utilization of gravity to produce a rotational output.

### SUMMARY OF THE INVENTION

A machine for converting a linear input to a rotary output is provided comprising: a rotatable member, an extendable and retractable member coupled to the rotatable member for rotation therewith, and a control that extends and retracts the extendable and retractable member during rotation of the rotatable member generally in relation to the angular position of the extendable and retractable member while tending to maintain the potential energy of the extendable and retractable member during at least part of extension and retraction.

A method for converting a linear input to a rotary output is also provided comprising: radially extending and retracting an extendable and retractable member coupled to a rotatable member as it rotates about an axis of rotation that has a vector component which extends perpendicularly to the direction of a gravitational field;

wherein the extending includes extending the extendable and retractable member generally in relation to the angular position of the extendable and retractable member with respect to such axis while tending to maintain the potential energy of the extendable and retractable member during at least part of extension.

Another method for converting a linear input to a rotary output is also provided comprising: radially extending and retracting an extendable and retractable member coupled to a rotatable member as it rotates about an axis of rotation that has a vector component which extends perpendicularly to the direction of a gravitational field;

wherein the retracting includes retracting the extendable and retractable member generally in relation to the angular position of the extendable and retractable member with respect to such axis while tending to maintain the potential energy of the extendable and retractable member during at least part of retraction.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an oblique view of an embodiment of the invention.

FIG. 2 is an end view looking down the axis of rotation Z of the embodiment of the invention shown in FIG. 1.

FIG. 3 is an end view looking down the axis of rotation Z of the embodiment of the invention shown in FIG. 1 showing the position of the extendable and retractable member at six circumferential locations.

FIGS. 4A-4L are schematic diagrams showing the radial position of the extendable and retractable member at twelve circumferential positions, looking down the axis of rotation Z.

FIG. 5 is a diagram of the path traveled by a moveable weight during a complete revolution of an extendable and retractable member.

FIG. 6 is an oblique view of a machine having three extendable and retractable members.

FIG. 7 is a cross-sectional view of a machine having three extendable and retractable members.

### DETAILED DESCRIPTION OF THE INVENTION

For the sake of facilitating this detailed description of the invention the approximate rotational positions are described relative to the typical twelve hours shown on the face of a clock. Six o'clock is oriented in the downward direction and twelve o'clock is oriented in the upward direction. Therefore, it will be appreciated that with this orientation, the six o'clock direction is the direction of the force of gravity.

Further, as used herein the term “upward sweep” refers to rotational movement in a direction opposed to the direction of the force of gravity. Similarly, with this orientation, 0 degrees corresponds to the 12 o'clock position and 180 degrees corresponds to the 6 o'clock position The term “downward sweep” refers to rotational movement in a direction coincidental to the direction of the force of gravity. Rotational movement from twelve o'clock to six o'clock, clockwise or counterclockwise is a downward sweep. Rotational movement from six o'clock to twelve o'clock, clockwise or counterclockwise, is an upward sweep.

It will also be appreciated that the actual rotational positions and paths traveled the components described herein are approximate. This is because in operation of the machine one or more components of the machine may be in the process of moving over a radial path while also undergoing rotation about a central axis. Thus, it is to be understood that the rotational positions set forth in the following description are merely illustrative and that in practice the rotational positions may differ.

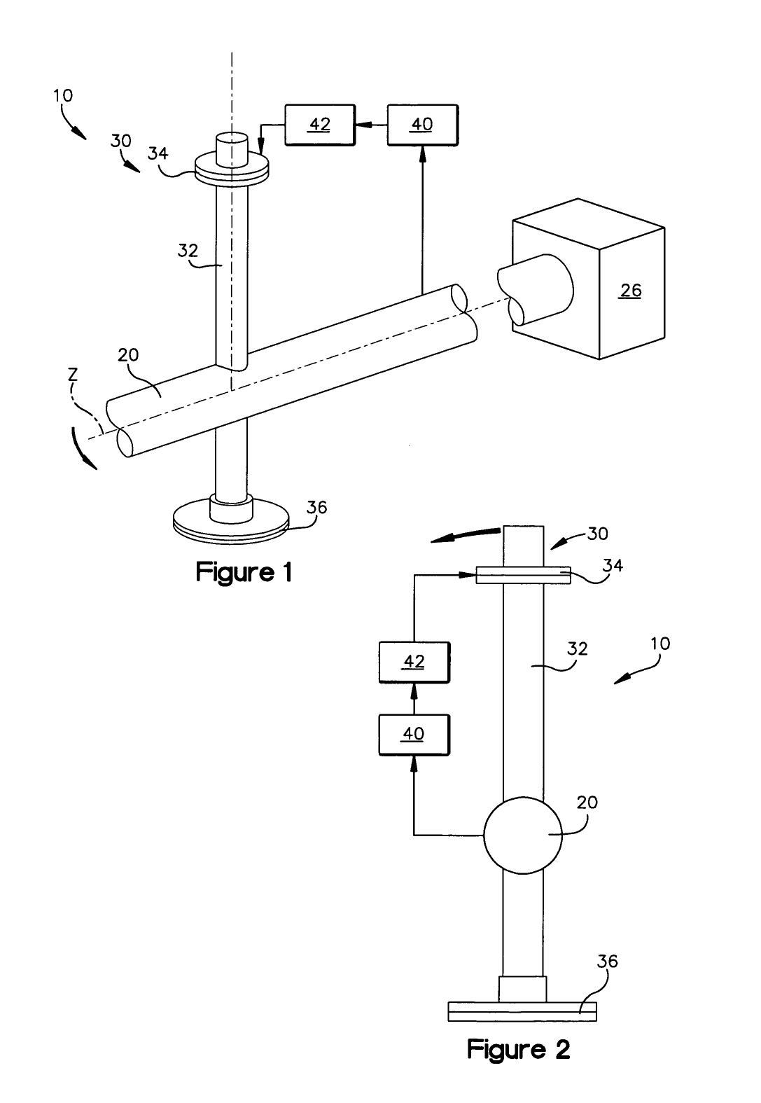

The following description is exemplary in nature and is in no way intended to limit the scope of the invention as defined by the claims appended hereto. Referring to FIGS. 1 and 2, a machine 10 is shown for converting a linear input to a rotary output. The machine includes a rotatable member 20 rotating about an axis of rotation Z and coupled to an output 26. An extendable and retractable member 30 is shown coupled to the rotatable member 20 for rotation therewith. The extendable and retractable member 30 is shown in FIGS. 1 and 2 coupled perpendicularly to the rotatable member 20 and extending through the rotatable member 20. However, other configurations are possible including extendable and retractable members that do not extend through the rotatable member 20 and are not perpendicular to the axis of rotation Z. The extendable and retractable member 30 includes a shaft 32, a movable weight 34 configured on the shaft 32 for radial movement, and a counterweight 36. A control 40 is configured to adjust the radial position of the movable weight 34 in response to the circumferential position of the movable weight 34 relative to the axis of rotation Z. The control 40 may operate a power or work input device 42 such as an electric, hydraulic, pneumatic, or magnetic motor that provides a work input to move the movable weight 34 along the shaft 32, e.g., as may be needed to overcome losses or the like in the machine 10 due to friction, air resistance, or other resistance to rotation of the rotatable member 20.

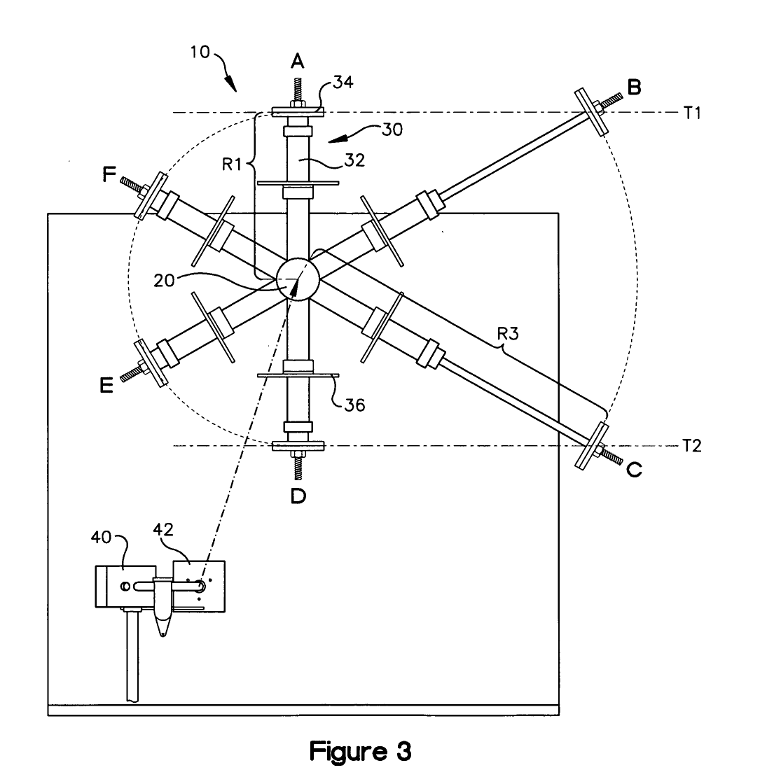

Turning to FIGS. 3-5, the operation of the machine 10 will be described. In FIG. 3, a diagram depicts the machine 10 in six positions. The machine 10 for converting a linear input to a rotary output is shown having a single extendable and retractable member 30. Six different circumferential positions, A, B, C, D, E, and F, of the extendable and retractable member 30 are indicated in FIG. 3. The radial position of the movable weight 34 in each of the circumferential positions is also shown. In this embodiment, the machine 10 for converting a linear input to a rotary output rotates in the clockwise direction.

Beginning at circumferential position A, the extendable and retractable member 30 is in the twelve o'clock position and the movable weight 34 is spaced radially from the axis of rotation Z a distance R1. As the extendable and retractable member 30 rotates from twelve o'clock at circumferential position A to two o'clock at circumferential position B (a downward sweep), the movable weight 34 is extended radially outward away from the axis of rotation Z to a distance R3. As the movable weight 34 is extended radially outward, it tends to maintain its potential energy by traveling along the horizontal path T1. T1 is a line tangent to the arc of rotation at twelve o'clock of the moveable weight 34 at a distance R1 from the axis of rotation Z. It will be appreciated that during the transition in radius from R1 to R3, the potential energy of the movable weight 34 is maintained while gravity inputs work to the system tending to rotate the extendable and retractable member 30, that in turn rotates the rotatable member 20. In an exemplary embodiment, the potential energy of the moveable weight 34 is maintained generally constant during the transition in radius from R1 to R3.

At circumferential position C, the extendable and retractable member 30 is in the four o'clock position. The movable weight 34 is spaced from the axis of rotation Z a distance R3. Thus, as the extendable and retractable member 30 rotates from two o'clock at circumferential position B to four o'clock at circumferential position C (a downward sweep), the movable weight 34 remains at a maximum distance R3 from the axis of rotation Z.

As the extendable and retractable member 30 rotates from four o'clock at circumferential position C to 6 o'clock at circumferential position D (a downward sweep), the movable weight 34 is retracted radially inward towards the axis of rotation Z such that the distance between the movable weight 34 and the axis of rotation Z, or radius, is returned to R1 when the extendable and retractable member 30 reaches six o'clock at circumferential position D. Thus, from circumferential position C to circumferential position D, the movable weight 34 tends to follow the horizontal line T2. T2 is a line tangent to the arc of rotation at six o'clock of the movable weight 34 at a distance R1 from the axis of rotation Z. Again, it will be appreciated that during the transition in radius from R3 to R1, the potential energy of the movable weight 34 is maintained while gravity inputs work to the system tending to rotate the extendable and retractable member 30, which in turn rotates the rotatable member 20. In an exemplary embodiment the potential energy of the moveable weight 34 is maintained generally constant during the transition in radius from R3 to R1.

As the extendable and retractable member 30 is rotated from six o'clock at circumferential position D through circumferential positions E and F and back to twelve o'clock at circumferential position A (an upward sweep), the radius remains R1. During this time, the moveable weight 34 is elevated from line T2 to line T1 and therefore must act against the force of gravity.

In the illustrated embodiment, R1 is approximately one-half the distance R3. For the sake of this description, it will be appreciated that the distance R1 is less than the distance R3. In addition, R1 and R3 may represent the respective minimum and maximum distances that the movable weight 34 is spaced from the axis of rotation Z at any point during a revolution. However, it will be appreciated that in some embodiments, R1 and R3 may not be the respective minimum and maximum distances that the movable weight 34 is spaced from the axis of rotation Z. For example, in some applications it may be desirable to further increase or decrease the radius of the movable weight 34 at the circumferential locations A, B, C, D, E, and F, or at other intermediate circumferential locations.

In general, the spacing between the movable weight 34 and the axis of rotation Z is greater during the downward sweep than during the upward sweep. That is, the radius of the movable weight 34 from the axis of rotation Z is generally greater on average when rotating from the twelve o'clock position A to the six o'clock position D than when rotating from the six o'clock position D to the twelve o'clock position A.

It will be appreciated that, by maintaining the potential energy of the movable weight 34 during segments of a revolution as described above, gravity can be utilized to produce a rotational output from a linear input.

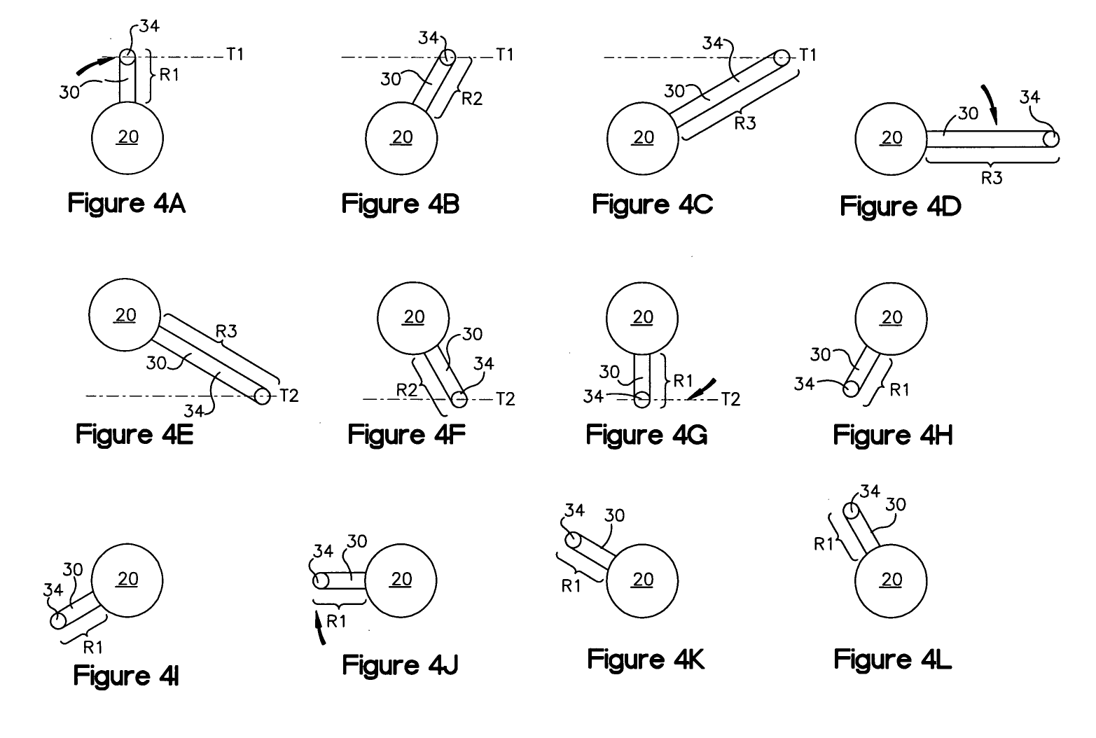

Turning to FIGS. 4A-4L, a more simplified illustration of an embodiment of the machine 10 of the present invention will be described. In FIGS. 4A-4L, the radial position of the movable weight 34 is shown at each of the twelve hour positions beginning with the twelve o'clock position 4A and rotating clockwise through the hours to the 11 o'clock position 4L. It will be appreciated that the center of the rotatable member 20 in each of the FIGS. 4A-4L is in the same relative position and the difference between the drawings is the relative position of the extendable and retractable member 30 and the relative position of the moveable weight 34.

Beginning in the twelve o'clock position as shown in 4A, the movable weight 34 is at radius R1. In FIG. 4B, the extendable and retractable member 30 is at one o'clock rotating clockwise (a downward sweep) while the movable weight 34 is extending radially outward. The radius of the movable weight 34 at this position is R2. It will be appreciated that R2 is an intermediate radius greater than R1 but less than R3. The position of the movable weight 34 is generally along a line T1 tangent to the arc of rotation at twelve o'clock of the movable weight 34 at a radius R1. Thus, the movable weight 34 in FIG. 4B has generally the same potential energy as when at twelve o'clock, as calculated by PE=mgh, wherein m is mass, g is the gravitational constant, and h is height. There is generally no loss of potential energy of the movable weight 34 while undergoing this movement even though the force of gravity is acting on the moveable weight 34 and the system through the extendable and retractable member 30.

In FIG. 4C, the extendable and retractable member 30 is rotating clockwise at 2 o'clock and the movable weight 34 is at radius R3. Again, the position of the movable weight 34 is generally along a line T1 tangent to the arc of rotation at twelve o'clock of the movable weight 34 at a radius R1. Thus, the movable weight 34 in FIG. 4C has generally the same potential energy as when it was at twelve and one o'clock, as calculated by PE=mgh, and this is when the system is gaining energy.

In FIG. 4D, the extendable and retractable member 30 is rotating clockwise at 3 o'clock and the movable weight 34 is at radius R3. Similarly, in FIG. 4E, the extendable and retractable member 30 is rotating clockwise at 4 o'clock and the movable weight 34 is at radius R3. In FIG. 4E, the movable weight 34 is generally along a line T2 tangent to the arc of rotation at six o'clock of the movable weight 34 at a radius R1.

In FIG. 4F, the extendable and retractable member 30 is rotating clockwise at five o'clock and the movable weight 34 is at radius R2. Again, the movable weight 34 is generally along a line T2 tangent to the arc of rotation at six o'clock of the movable weight 34 at a radius R1.

In FIG. 4G, the extendable and retractable member 30 is rotating clockwise at six o'clock and the movable weight 34 is at radius R1. It will be appreciated that from four o'clock to six o'clock the movable weight 34 travels along the horizontal line T2 tangent to the arc of rotation at six o'clock of the movable weight 34 at a radius R1. Therefore, the potential energy of the movable weight 34 is essentially constant from the four o'clock position seen in FIG. 4E to the six o'clock position seen in FIG. 4G, as calculated by PE=mgh.

During the remaining portion of the revolution of the extendable and retractable member 30 from six o'clock in FIG. 4G to 12 o'clock in FIG. 4L (upward swing), the extendable and retractable member 30 is rotating clockwise and the movable weight 34 is at radius R1.

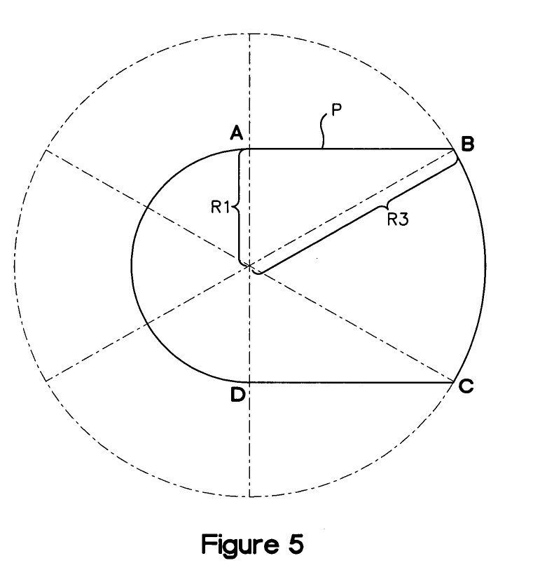

Turning now to FIG. 5, a diagram is shown depicting the path P traveled by a moveable weight 34 during the clockwise revolution of an extendable and retractable member 30 in a typical embodiment of the present invention. It will be appreciated that the path P is equally applicable to the moveable weight 34 of a single extendable and retractable member machine 10 or a multiple extendable and retractable member machine 10′. A circle 100 divided into six equal portions is superimposed in phantom over the path P. Location A is at the twelve o'clock position, location B is at the two o'clock position, location C is at the four o'clock position, and location D is at the six o'clock position.

Beginning at 12 o'clock in location A as the extendable and retractable member 30 begins a downward sweep, the moveable weight 34 travels horizontally along the line A-B to two o'clock in location B. This movement of the moveable weight 34 is indicative of an extension of the radius of the moveable weight 34 from R1 to R3 as shown. From two o'clock in location B, the moveable weight 34 maintains radius R3 as it rotates along the arc B-C to 4 o'clock in location C. The moveable weight 34 then travels horizontally along line C-D to six o'clock in location D, where it is at radius R1. From six o'clock in location D to twelve o'clock in location A the extendable and retractable member 30 is in an upward swing and the moveable weight 34 travels along the arc D-A thereby maintaining the radius R1. Collectively, lines A-B and C-D, and arcs B-C and D-A, form the path P.

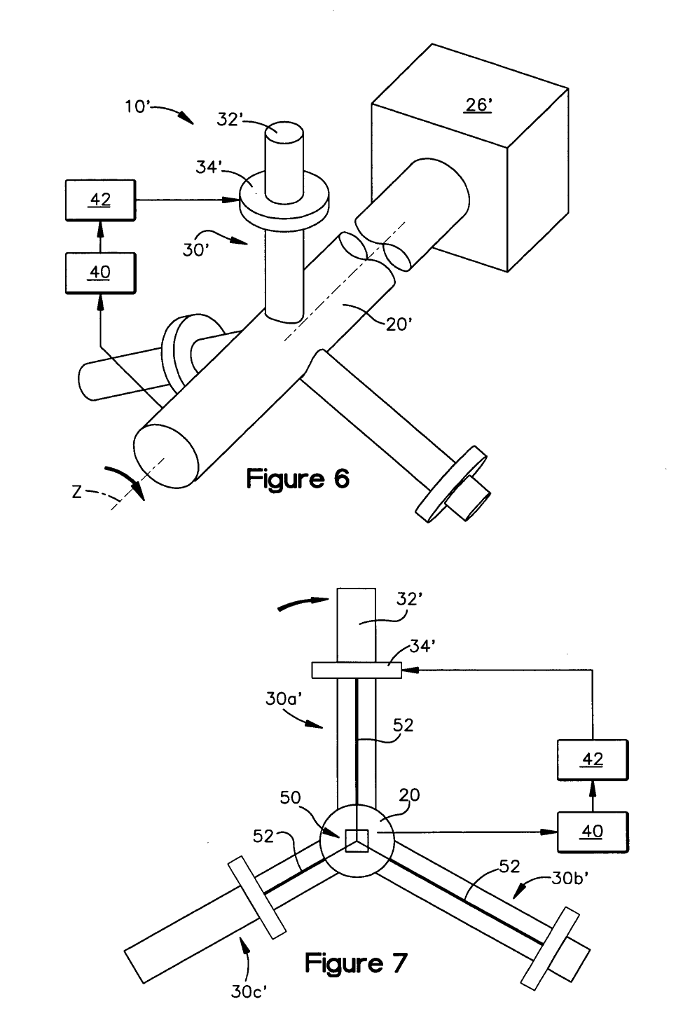

In FIG. 6, a machine 10′ (primed reference numerals designate elements that are similar to elements designated by the same non-primed numerals) having three extendable and retractable members 30′ space uniformly around a rotatable member 20′ is shown. In this embodiment, the three extendable and retractable members 30′ each function individually in a similar manner as described previously with respect to a single extendable and retractable member 30′ machine. That is, as each extendable and retractable member 30′ rotates about the axis of rotation Z′, the movable weight 34′ of each extendable and retractable member 30′ is extended or retracted radially by the control 40′ as a function of the circumferential position of each respective extendable and retractable member 30′. Due to the additional extendable and retractable members 30′, this embodiment may achieve a more balanced machine 10′ and may increase efficiency over a single extendable and retractable member machine 10 through energy exchanges arranged between the plurality of extendable and retractable members 30′.

It will be appreciated that, in general, any suitable number of extendable and retractable members 30′ may be used to practice the present invention, the primary consideration being the extension and retraction of the members in the manner previously set forth. Further, the extendable and retractable members 30′ can be arranged along axis Z of the rotatable member 20′ such that one or more extendable and retractable members 30′ are in different axial planes (i.e., planes extending through the axis Z).

In a machine 10′ having multiple extendable and retractable members 30′, it may be advantageous to provide a linkage that hydraulically, mechanically, or otherwise links the individual extendable and retractable members 30′ such that the extension of one moveable weight 34′ couples to the retraction of another moveable weight 34′. Such an interlink between two or more extendable and retractable members 30′ may provide additional increases in efficiency by facilitating energy transfer between the extendable and retractable members 30′ during extension and retraction, thereby preserving system energy, and increasing overall efficiency.

For example, in FIG. 7 a machine 10′ having three extendable and retractable members 30a′, 30b′, and 30c′ is shown including a linkage device 50. The linkage device 50 may be hydraulic, pneumatic, mechanical, magnetic, etc. Linkage members 52 link each extendable and retractable member 30a′, 30b′, 30c′ together via the linkage device 50. The linkage device 50 can provide for the extendable and retractable members 30a′, 30b′, 30c′ to exchange energy during extension and retraction. Thus, as one extendable or retractable member 30a′, 30b′, 30c′ is extended, one or both of the other extendable and retractable members 30a′, 30b′, 30c′ may be retracted. It will be appreciated that the rotational kinetic energy of an extendable and retractable member 30a′, 30b′, 30c′ tends to decrease during extension and increase during retraction. The increase in rotational kinetic energy is supplied by the energy input required to retract the extendable and retractable member 30a′, 30b′, 30c′ inwardly. Therefore, by linking the extendable and retractable members 30a′, 30b′, 30c′, the linkage device 50 can transfer at least a portion of the energy input required to retract the extendable and retractable members 30a′, 30b′, 30c′ by providing for the transfer of rotational energy from an extending extendable and retractable member 30a′, 30b′, 30c′ to a retracting extendable and retractable member 30a′, 30b′, 30c′. For example, the linkage device 50 provides for the transfer of rotational energy from an extending extendable and retractable member 30a′ to a retracting extendable or retractable member 30b′. As the machine rotates, energy from extendable and retractable member 30b′ is then linked and exchanged with extendable and retractable member 30c′ and so on throughout the system, energy being progressively exchanged between typically adjacent extendable and retractable members. In this manner, the linkage device 50 may tend to further increase the efficiency of the machine 10′ by facilitating these transfers of energy. As previously mentioned, in a multiple extendable and retractable member machine 10′, the members 30a′, 30b′, 30c′ can be offset axially along the axis Z. Such and arrangement of the extendable and retractable members 30a′, 30b′, 30c′ can be advantageous when utilizing the linking device 50 to exchange energy between the extendable and retractable members 30a′, 30b′, 30c′.

The linkage device 50 described above with reference to a three extendable and retractable member machine 10′ can be incorporated into a machine having any number of extendable and retractable members 30. Furthermore, when two or more extendable and retractable members 30 are linked to exchange energy, it may be sufficient or advantageous to maintain the potential energy of the linked extendable and retractable members 30 as a group, rather than the potential energy of each member 30 as the linked members 30 are exchanging energy and in the process of extension or retraction. In a single extendable and retractable member machine 10, the linkage device 50 can link the extendable and retractable member 30 to a stationary counterweight capable of storing/restoring the energy of the extendable and retractable member 30 as it is extended and retracted, respectively. The energy may be stored in kinetic or non-kinetic form. As another example, a resilient member, such as a spring, may be used to store potential energy.

The extendable and retractable members 30a′, 30b′, and 30c′, as described above, include a shaft 32′ and a moveable weight 34′ coupled thereto. However, the moveable weight 34′ may be integral with the extendable and retractable members 30a′, 30b′, 30c′ such that the extension or retraction of an extendable and retractable member 30a′, 30b, 30c′ functions the same as an extension or retraction of the moveable weight 34′ as described above.

In general, the control system 40 in any of the above described embodiments may be a computer, electromechanical switching apparatus, or any other suitable control device. One or more electric or magnetic fields produced by devices such as solenoids and electromagnets can be used to effect retraction and extension of the extendable and retractable members 30, 30′. Certain mechanical devices, such as geneva gears, can also be configured to control extension and retraction. Hydraulic or pneumatic pressure also can be used to actuate the extendable and retractable members 30, 30′. Suitable pumps and/or check valves can be used to control the flow of a fluid in a hydraulicly or pneumatically operated system.

For example, in a hydraulically linked system a first extendable and retractable member 30a′ can be extended, the energy released during extension thereof being transferred hydraulically via the linkage system and one or more pumps and/or check valves and utilized to retract a second extendable and retractable member 30b′. A check valve can be used to maintain the retracted extendable and retractable member 30b′ in the retracted position. As the second extendable and retractable member 30b′, rotates and begins to extend, the energy released from the second extendable and retractable member 30b′ can be transferred to the third extendable and retractable member 30c′. This process can be repeated thereby minimizing system energy losses.

It will be appreciated that system energy will be lost or consumed during movement of the extendable and retractable members 30, 30′ in any of the above embodiments. As such, the pumps or other devices as described above can be utilized to provide energy to the system to offset such losses and thereby improve overall efficiency of the system.

An extendable and retractable member 30, 30′ in any of the above embodiments can be configured with the rotatable member 20, 20′ such that the extendable and retractable member 30, 30′ can shift radially about the rotatable member 20, 20′ a predetermined amount. This radial “play” about the rotatable member 20, 20′ can be advantageous for maximizing the system efficiency, particularly in multiple extendable and retractable member 30, 30′ embodiments.

It will be appreciated that the rotatable member 20, 20′ may be coupled to any suitable output device 26, 26′. The output device 26, 26′ may be any device that receives rotational input such as a generator, an alternator, a drive shaft, a direct drive, etc.

It will further be appreciated that the axis Z is this description and the axis of rotation referred to in the claims can be any non-vertical axis, vertical being defined as the direction of a field of gravity. Therefore, it will be understood that the axis Z and/or axis of rotation of the rotatable member can extend in any direction relative to the direction of a field of gravity provided that axis has a vector component which extends perpendicularly to the direction of the gravitational field.

Although the present invention has been described in the context of increasing the rotational efficiency of a rotatable member 20, 20′, the present invention is equally well suited to braking the rotation of a rotatable member 20, 20′ by operating the machine in a reverse mode. In such a configuration, for example with reference to FIG. 4A-4L, the moveable weight 34, 34′ would be extended to the larger radius of rotation R3 during the upward sweep and returned to the smaller radius of rotation R1 prior to the downward sweep. In this manner, the effect of gravity on the system would be against the direction of rotation of the rotatable member 20, and thereby tend to dampen energy from the machine 10, 10′. Configuring the machine 10, 10′ in such a reverse mode may be useful, for example, for braking and/or decreasing the rate of rotation of a rotatable member such as a drive shaft of a vehicle.

It will be appreciated that the rotary output from the machine 10, 10′ of the present invention may be used for a wide variety of purposes that require power input or power braking, particularly in situations using rotary motion power.

Although the invention has been shown and described with respect to certain preferred embodiments, other equivalents and modifications will occur to others skilled in the art upon the reading and understanding of the specification. The present invention includes all such equivalents and modifications, and is limited only by the scope of the following claims.

1. A machine for converting a linear input to a rotary output, comprising:
a rotatable member;
an extendable and retractable member coupled to the rotatable member for rotation therewith; and
a control that extends and retracts the extendable and retractable member during rotation of the rotatable member generally in relation to the angular position of the extendable and retractable member while tending to maintain the potential energy of the extendable and retractable member during at least part of extension and retraction.

2. The machine as set forth in claim 1, wherein the rotatable member has an axis of rotation that has a vector component which extends perpendicularly to the direction of a gravitational field.

3. The machine as set forth in claim 2, wherein the control extends the extendable and retractable member when the extendable and retractable member is rotated about such axis between a position 180 degrees from such direction and about 240 degrees relative to such direction measured in the direction of rotation.

4. The machine as set forth in claim 2, wherein the control retracts the extendable and retractable member when the extendable and retractable member is rotated about such axis between about 300 degrees and about 360 degrees relative to such direction measured in the direction of rotation.

5. The machine as set forth in claim 2, wherein the control maintains the radial position of the extendable and retractable member when the extendable and retractable member is rotated about such axis between about 0 degrees and about 180 degrees relative to such direction, and between about 240 degrees and about 300 degrees relative to such direction measured in the direction of rotation.

6. (canceled)

7. (canceled)

8. The machine as set forth in claim 1, wherein the extendable and retractable member extends radially outward from the axis of rotation and retracts radially inward toward the axis of rotation.

9. The machine as set forth in claim 1, wherein the extendable and retractable member includes at least one weight movable on a radial support.

10. The machine as set forth in claim 1, wherein the control extends and retracts the extendable and retractable member with hydraulic pressure.

11. The machine as set forth in claim 1, wherein the control extends and retracts the extendable and retractable member with pneumatic pressure.

12. The machine as set forth in claim 1, wherein the control extends and retracts the extendable and retractable member with at least one magnetic force generated by at least one magnetic field.

13. The machine as set forth in claim 1, wherein the control extends and retracts the extendable and retractable member with mechanical work.

14. The machine as set forth in claim 1, further comprising a plurality of extendable and retractable members movable in a radial direction relative to the axis of rotation.

15. The machine as set forth in claim 14, wherein the plurality of extendable and retractable members comprise three extendable and retractable members located at approximately 120 degrees spacing relative to each other about the rotatable member.

16. The machine as set forth in claim 14, wherein each extendable and retractable member is linked to at least one other extendable and retractable member for movement therewith.

17. The machine as set forth in claim 16, wherein each extendable and retractable member is linked to at least one other extendable and retractable member such that work from the extension of one extendable and retractable member is provided to assist in retraction of another extendable and retractable member.

18. The machine as set forth in claim 16, wherein the at least one extendable and retractable member is linked mechanically to at least one other extendable and retractable member for movement therewith.

19. The machine as set forth in claim 16, wherein the at least one extendable and retractable member is linked fluidicly to at least one other extendable and retractable member for movement therewith.

20. A method of providing a rotational output in response to a linear input comprising:
radially extending and retracting an extendable and retractable member coupled to a rotatable member as it rotates about an axis of rotation that has a vector component which extends perpendicularly to the direction of a gravitational field;
wherein the extending includes extending the extendable and retractable member generally in relation to the angular position of the extendable and retractable member with respect to such axis while tending to maintain the potential energy of the extendable and retractable member during at least part of extension.

21. The method as set forth in claim 20, further comprising retracting the extendable and retractable member generally in relation to the angular position of the extendable and retractable member with respect to such axis while tending to maintain the potential energy of the extendable and retractable member during at least part of retraction.

22. The method of claim 21, wherein the extending of the extendable and retractable member is performed when the extendable and retractable member is between 180 and 240 degrees relative to such axis of rotation measured relative to the direction of the gravitational field in the direction of rotation.

23. The method of claim 21, wherein the retracting of the extendable and retractable member is performed when the extendable and retractable member is between 300 and 360 degrees relative to such axis of rotation measured relative the direction of the gravitational field in the direction of rotation.

24. A method of providing a rotational output in response to a linear input comprising:
radially extending and retracting an extendable and retractable member coupled to a rotatable member as it rotates about an axis of rotation that has a vector component which extends perpendicularly to the direction of a gravitational field;
wherein the retracting includes retracting the extendable and retractable member generally in relation to the angular position of the extendable and retractable member with respect to such axis while tending to maintain the potential energy of the extendable and retractable member during at least part of retraction.

25. The method of claim 24, wherein the retracting of the extendable and retractable member is performed when the extendable and retractable member is between 300 and 360 degrees relative to the direction of the gravitational field measured in the direction of rotation.
